(19) United States
(12) Patent Application Publication
(10) Pub. No.: US 2026/0333147 A1
(43) Pub. Date: Oct. 22, 2026

(54) APPARATUS AND METHOD FOR HANDLING CELL SWITCH OFF FOR NETWORK ENERGY SAVING IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Sangkyu BAEK, Suwon-si (KR)

(21) Appl. No.: 19/113,207

(22) PCT Filed: Sep. 22, 2023
(86) PCT No.: PCT/KR2023/014541

§ 371 Date: Mar. 19, 2025

(30) Foreign Application Priority Data
Oct. 21, 2022 (KR) 10-2022-0136412

(51) Int. Cl. H04W 36/00; H04W 36/30; H04W 52/02

(52) U.S. Cl. CPC H04W 36/0072; H04W 36/0069; H04W 36/305; H04W 52/0206

(57) ABSTRACT

The disclosure relates to a 5G or 6G communication system for supporting a higher data transmission rate. Specifically, present disclosure provides method and apparatus for handling cell switch off (or, cell off) with regard to NES in wireless communication system.

### TECHNICAL FIELD

The disclosure relates to a wireless communication system (or a mobile communication system). Specifically, the disclosure relates to an apparatus, a method and a system for handling cell switch off for network energy saving (NES) in wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Recently, there are needs to enhance cell switch off handling procedures with regard to the NES developments.

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, information indicating a cell off of a first cell; and performing an operation based on the information, according to whether the first cell is a secondary cell (SCell), or a primary secondary cell group cell (PSCell), or a primary cell (PCell), in case that the first cell is the SCell, the SCell is released or deactivated, in case that the first cell is the PSCell, a secondary cell group (SCG) including the PSCell is released or deactivated, or a radio link failure (RLF) is declared for the SCG, and in case that the first cell is the PCell, a second cell is switched to a new PCell, a radio resource control (RRC) re-establishment is performed, or a handover from the first cell to a third cell is performed.

In accordance with another aspect of the disclosure, a terminal is provided. The terminal comprises: a transceiver; and a controller coupled with the transceiver and configured to: receive, from a base station, information indicating a cell off of a first cell, and perform an operation based on the information, according to whether the first cell is a secondary cell (SCell), or a primary secondary cell group cell (PSCell), or a primary cell (PCell), in case that the first cell is the SCell, the SCell is released or deactivated, in case that the first cell is the PSCell, a secondary cell group (SCG) including the PSCell is released or deactivated, or a radio link failure (RLF) is declared for the SCG, and in case that the first cell is the PCell, a second cell is switched to a new PCell, a radio resource control (RRC) re-establishment is performed, or a handover from the first cell to a third cell is performed.

In accordance with another aspect of the disclosure, a method performed by a base station is provided. The method comprises: transmitting, to a terminal, information indicating a cell off of a first cell; and performing an operation based on the information, according to whether the first cell is a secondary cell (SCell), or a primary secondary cell group cell (PSCell), or a primary cell (PCell), in case that the first cell is the SCell, the SCell is released or deactivated, in case that the first cell is the PSCell, a secondary cell group (SCG) including the PSCell is released or deactivated, or a radio link failure (RLF) is reported for the SCG, and in case that the first cell is the PCell, a second cell is switched to a new PCell, a radio resource control (RRC) re-establishment is performed, or a handover from the first cell to a third cell is performed.

In accordance with another aspect of the disclosure, a base station is provided. The base station comprises: a transceiver; and a controller coupled with the transceiver and configured to: transmit, to a terminal, information indicating a cell off of a first cell, and perform an operation based on the information, according to whether the first cell is a secondary cell (SCell), or a primary secondary cell group cell (PSCell), or a primary cell (PCell), in case that the first cell is the SCell, the SCell is released or deactivated, in case that the first cell is the PSCell, a secondary cell group (SCG) including the PSCell is released or deactivated, or a radio link failure (RLF) is reported for the SCG, and in case that the first cell is the PCell, a second cell is switched to a new PCell, a radio resource control (RRC) re-establishment is performed, or a handover from the first cell to a third cell is performed.

### Advantageous Effects of Invention

According to various embodiments of the disclosure, handling of cell switch off procedures can be efficiently enhanced with regard to NES.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a handover procedure for supporting cell level mobility in accordance with an embodiment of the disclosure.

FIG. 2 illustrates an example of cell switch off (or, cell off) handling procedure in accordance with an embodiment of the disclosure.

FIG. 3 illustrates another example of cell switch off (or, cell off) handling procedure in accordance with an embodiment of the disclosure.

FIG. 4 illustrates another example of cell switch off (or, cell off) handling procedure in accordance with an embodiment of the disclosure.

FIG. 5 illustrates another example of cell switch off (or, cell off) handling procedure in accordance with an embodiment of the disclosure.

FIG. 6 illustrates another example of cell switch off (or, cell off) handling procedure in accordance with an embodiment of the disclosure.

FIG. 7 is a block diagram of a terminal according to an embodiment of the disclosure.

FIG. 8 is a block diagram of a base station according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Example use cases the fifth generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IOT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

The fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilize radio resources provided by two distinct schedulers, located in two different nodes connected via a non-ideal backhaul and providing either Evolved Universal Mobile Telecommunication System (UMTS) Terrestrial Radio Access (E-UTRA) (i.e., if the node is an ng-eNB) or NR access (i.e., if the node is a gNB). In NR, for a UE in RRC_CONNECTED not configured with CA/DC there is only one serving cell comprising of the primary cell (PCell). For a UE in RRC_CONNECTED configured with CA/DC the term ‘serving cells’ is used to denote the set of cells comprising of the Special Cell(s) and all secondary cells (SCells). In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. PSCell refers to a serving cell in SCG in which the UE performs random access when performing the Re-configuration with Sync procedure. For Dual Connectivity operation the term SpCell (i.e., Special Cell) refers to the PCell of the MCG or the PSCell of the SCG, otherwise the term Special Cell refers to the PCell.

In the fifth generation wireless communication system, Physical Downlink Control Channel (PDCCH) is used to schedule downlink (DL) transmissions on Physical Downlink Shared Channel (PDSCH) and uplink (UL) transmissions on Physical Uplink Shared Channel (PUSCH), where the Downlink Control Information (DCI) on PDCCH includes: Downlink assignments containing at least modulation and coding format, resource allocation, and hybrid automatic repeat request (HARQ) information related to downlink shared channel (DL-SCH); Uplink scheduling grants containing at least modulation and coding format, resource allocation, and hybrid-ARQ information related to uplink shared channel (UL-SCH). A UE monitors a set of PDCCH candidates in the configured monitoring occasions in one or more configured COntrol REsource SETs (CORESETs) according to the corresponding search space configurations. A CORESET consists of a set of physical resource blocks (PRBs) with a time duration of 1 to 3 orthogonal frequency division multiplexing (OFDM) symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. Quadrature Phase Shift Keying (QPSK) modulation is used for PDCCH.

In fifth generation wireless communication system, a list of search space configurations is signaled by GNB for each configured BWP wherein each search configuration is uniquely identified by an identifier. Identifier of search space configuration to be used for specific purpose such as paging reception, system information (SI) reception, random access response reception is explicitly signaled by gNB.

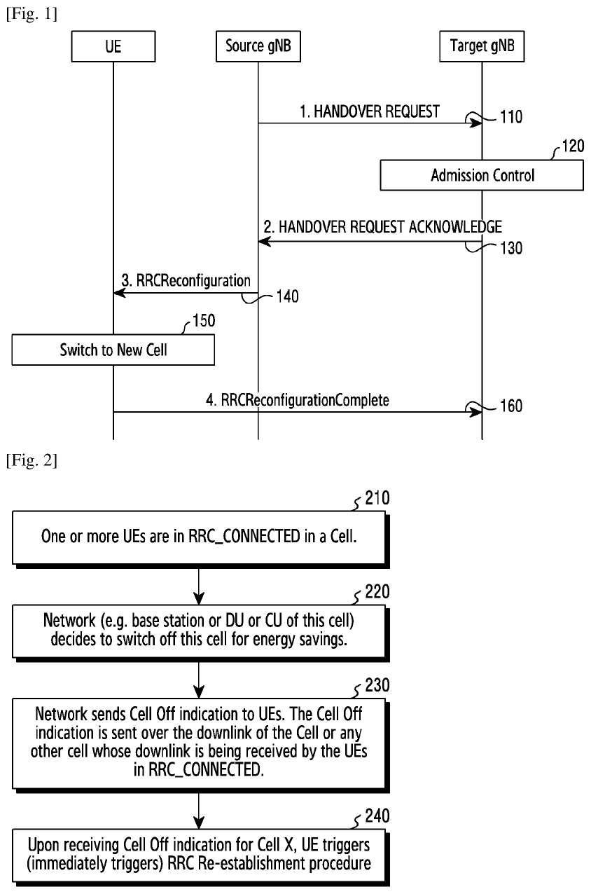

Mobility in in fifth generation wireless communication system: There are two types of mobility, cell level mobility and beam level mobility. Cell Level Mobility requires explicit radio resource control (RRC) signaling to be triggered, i.e. handover. For inter-gNB handover, the signaling procedures consist of at least the following elemental components as shown in FIG. 1 below. FIG. 1 illustrates a handover procedure for supporting cell level mobility in accordance with an embodiment of the disclosure.

The source gNB initiates handover and issues a HANDOVER REQUEST over the Xn interface (110). The target gNB performs admission control and provides the new RRC configuration as part of the HANDOVER REQUEST ACKNOWLEDGE (120, 130). The source gNB provides the RRC configuration to the UE by forwarding the RRCReconfiguration message received in the HANDOVER REQUEST ACKNOWLEDGE (140). The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any. The UE moves the RRC connection to the target gNB and replies with the RRCReconfigurationComplete (150, 160). Several types of handover, normal handover, conditional handover and DAPS handover are supported.

Beam Level Mobility does not require explicit RRC signaling to be triggered. The gNB provides for serving cell via RRC signaling the UE with measurement configuration containing configurations of synchronization signal and physical broadcast channel block (SSB)/channel state information (CSI) resources and resource sets, reports and trigger states for triggering channel and interference measurements and reports. Beam Level Mobility is then dealt with at lower layers by means of physical layer and medium access control (MAC) layer control signaling, and RRC is not required to know which beam is being used at a given point in time. Based on physical layer and MAC layer control signaling UE can be switched from one beam to another in serving cell.

For network energy saving (NES), network may decide to switch off one or more cells. The consequence is that UEs in RRC_CONNECTED will eventually encounter radio link failure (RLF). RLF will trigger RRC_CONNECTION re-establishment procedure. There is a time delay (i.e., T=T1+T2) between the time cell is switched off and RLF is declared, where T1 is a time interval for N310 consecutive “out-of-sync” indications for the SpCell from lower layers, the value of T1 depends on radio link monitoring (RLM) reference signal (RS) periodicity, and where T2 is a RLF timer (T310) (e.g., 50 ms to 6 s). Due to the time delay, the recovery of RRC connection upon switching off cell is delayed. Various

### Method 1

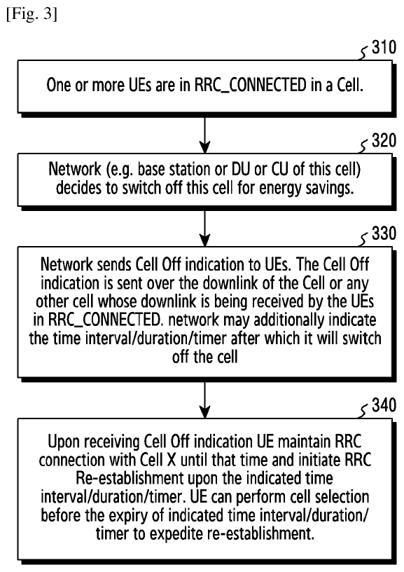

FIG. 2 and FIG. 3 illustrate examples of cell switch off (or, cell off) handling procedures in accordance with embodiments of the disclosure.

One or more UEs are in RRC_CONNECTED in a Cell (e.g., Cell X) (210, 310). Network (e.g., gNB or base station or distributed unit (DU) or central unit (CU) of this cell) decides to switch off this cell for energy savings (220, 320). Cell can be an SpCell or an SCell.

In an embodiment of FIG. 2, network sends Cell Off indication to the one or more UEs (230). The Cell Off indication is sent over the downlink of Cell X or any other cell whose downlink is being received by the one or more UEs in RRC_CONNECTED.
The Cell Off indication can be indicated/signaled in MAC CE or DCI or RRC message.
   In case MAC CE is used, the PDCCH scheduling the transport block (TB) including the MAC CE is addressed to cell radio network temporary identifier (C-RNTI) or pre-defined RNTI or common RNTI signaled by RRC (e.g., RRCReconfiguration message). PDCCH addressed to C-RNTI or pre-defined RNTI or common RNTI means the cyclic redundancy check (CRC) of DCI transmitted on PDCCH is scrambled by the C-RNTI or pre-defined RNTI or common RNTI. Common RNTI can be signaled by network when the UE is in RRC_CONNECTED state.
   In case DCI is used, the PDCCH is addressed to C-RNTI or pre-defined RNTI or common RNTI signaled by RRC (e.g., RRCReconfiguration message).
   In case RRC message is used, the PDCCH scheduling the TB including the RRC message can be addressed to C-RNTI or pre-defined RNTI or common RNTI signaled by RRC (e.g., RRCReconfiguration message).
The Cell Off indication can also be signaled/indicated in system information (SI), e.g., master information block (MIB) or system information block 1 (SIB1) or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to paging RNTI (P-RNTI).
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

Upon receiving Cell Off indication for Cell X in FIG. 2, UE triggers (or, immediately triggers) RRC Re-establishment procedure (240). In an embodiment RRC Re-establishment is triggered if the Cell X is SpCell.

During RRC Re-establishment, UE selects cell other than Cell X

In another embodiment of FIG. 3, network may additionally indicate the time interval/duration/timer after which it will switch off the cell from the end of slot/ symbol/subframe/frame in which Cell Off indication is transmitted/received by network/UE (330) or at an offset (can be signaled in RRC message or in Cell Off indication) from the end of slot/symbol/subframe/frame in which Cell Off indication is transmitted/received by network/UE (330) or from the end of reference slot/ symbol/subframe/frame indicated (e.g. in Cell Off indication) by network. The time interval/duration/timer can be seconds/milli seconds/number of slots/ subframes/symbols/frames, etc.

Upon receiving Cell Off indication, UE maintains RRC connection with Cell X until that time, and UE initiates RRC Re-establishment upon the indicated time interval/ duration/timer (340). UE can perform cell selection before the expiry of indicated time interval/duration/timer to expedite re-establishment.

In an embodiment, upon reception of Cell Off indication for PCell, UE declares MCG RLF, and if UE is configured with activated PSCell, MCG Recovery by MCG Failure Information can be triggered. MCG Failure Information is transmitted via SCG to PSCell.

### Method 2

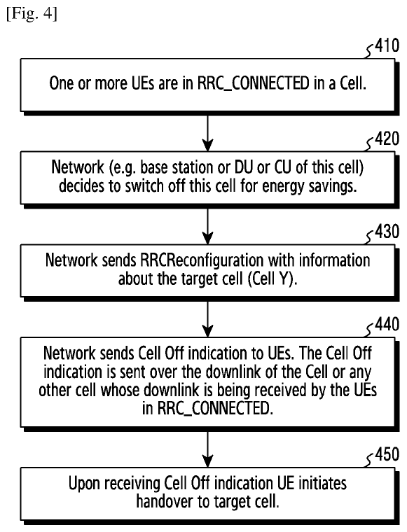

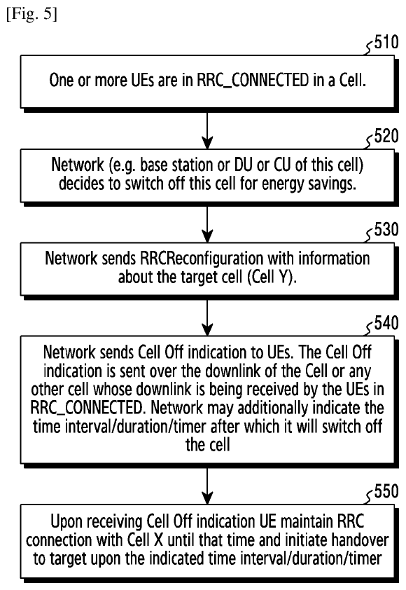

FIG. 4 and FIG. 5 illustrate examples of cell switch off (or, cell off) handling procedures in accordance with embodiments of the disclosure.

One or more UEs are in RRC_CONNECTED in a Cell (e.g., Cell X) (410, 510). Network (e.g., gNB or base station or DU or CU of this cell) decides to switch off this cell for energy savings (420, 520). Cell can be an SpCell or an SCell.

Network sends RRCReconfiguration with information about the target cell (e.g., Cell Y) (430, 530). RRCReconfiguration is specific to each of the one or more UEs. In an embodiment, RRCReconfiguration with information about the target cell can be commonly sent to all UEs.

In an embodiment of FIG. 4, network sends Cell Off indication to one or more UEs (440). The Cell Off indication is sent over the downlink of Cell X or any other cell whose downlink is being received by the one or more UEs in RRC_CONNECTED.
The Cell Off indication can be indicated/signaled in MAC CE or DCI or RRC message.
   In case MAC CE is used, the PDCCH scheduling the TB including the MAC CE is addressed to C-RNTI or pre-defined RNTI or common RNTI signaled by RRC (e.g., RRCReconfiguration message). PDCCH addressed to C-RNTI or pre-defined RNTI or common RNTI means the CRC of DCI transmitted on PDCCH is scrambled by the C-RNTI or pre-defined RNTI or common RNTI. Common RNTI can be signaled by network when the UE is in RRC_CONNECTED state.
   In case DCI is used, the PDCCH is addressed to C-RNTI or pre-defined RNTI or common RNTI signaled by RRC (e.g., RRCReconfiguration message).
   In case RRC message is used, the PDCCH scheduling the TB including the RRC message can be addressed to C-RNTI or pre-defined RNTI or common RNTI signaled by RRC (e.g., RRCReconfiguration message).
The Cell Off indication can also be signaled/indicated in system information (SI), e.g., MIB or SIB1 or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to P-RNTI.
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

The Cell Off indication can also be referred as the indication to execute/initiate handover to the target cell.

Upon receiving Cell Off indication for Cell X (FIG. 4), UE initiates handover to the target cell (450).

In another embodiment of FIG. 5, network may additionally indicate the time interval/duration/timer after which it will switch off the cell from the end of slot/ symbol/subframe/frame in which Cell Off indication is transmitted/received by network/UE (540) or at an offset (can be signaled in RRC message or in Cell Off indication) from the end of slot/symbol/subframe/frame in which Cell Off indication is transmitted/received by network/UE (540) or from the end of reference slot/ symbol/subframe/frame indicated (e.g. in Cell Off indication) by network. The time interval/duration/timer can be seconds/milli seconds/number of slots/ subframes/symbols/frames etc.

Upon receiving Cell Off indication UE maintain RRC connection with Cell X until that time and initiate handover to target upon the indicated time interval/duration/timer (550).

### Method 3

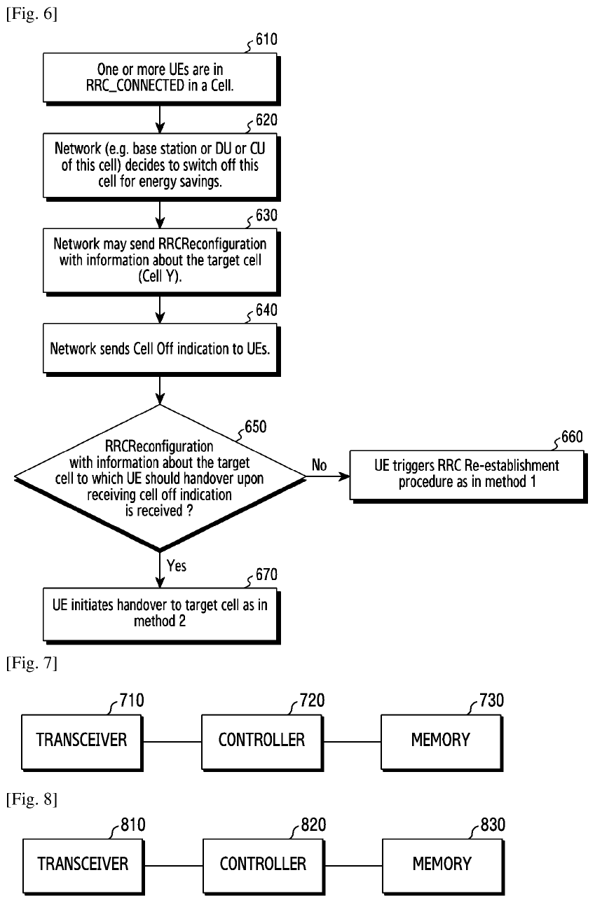

FIG. 6 illustrates an example of cell switch off (or, cell off) handling procedure in accordance with an embodiment of the disclosure.

One or more UEs are in RRC_CONNECTED in a Cell (e.g., Cell X) (610). Network (e.g., gNB or base station or DU or CU of this cell) decides to switch off this cell for energy savings (620). Cell can be an SpCell or an SCell.

Network may send RRCReconfiguration with information about the target cell (e.g., Cell Y) (630). RRCReconfiguration is specific to each of the one or more UEs. In an embodiment, RRCReconfiguration with information about the target cell can be commonly sent to all UEs.

Network sends Cell Off indication to one or more UEs (640). The Cell Off indication is sent over the downlink of Cell X or any other cell whose downlink is being received by the UEs in RRC_CONNECTED.
The Cell Off indication can be indicated/signaled in MAC CE or DCI or RRC message.
   In case MAC CE is used, the PDCCH scheduling the TB including the MAC CE is addressed to C-RNTI or pre-defined RNTI or common RNTI signaled by RRC (e.g., RRCReconfiguration message). PDCCH addressed to C-RNTI or pre-defined RNTI or common RNTI means the CRC of DCI transmitted on PDCCH is scrambled by the C-RNTI or pre-defined RNTI or common RNTI. Common RNTI can be signaled by network when the UE is in RRC_CONNECTED state.
   In case DCI is used, the PDCCH is addressed to C-RNTI or pre-defined RNTI or common RNTI signaled by RRC (e.g., RRCReconfiguration message).
   In case RRC message is used, the PDCCH scheduling the TB including the RRC message can be addressed to C-RNTI or pre-defined RNTI or common RNTI signaled by RRC (e.g., RRCReconfiguration message).
The Cell Off indication can also be signaled/indicated in system information (SI), e.g., MIB or SIB1 or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to P-RNTI.
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

The Cell Off indication can also be referred as the indication to execute/initiate handover to the target cell.

Upon receiving Cell Off indication for Cell X of FIG. 6, UE check if RRCReconfiguration with information about the target cell to which UE should handover upon receiving cell off indication is received or not (650).
If RRCReconfiguration with information about the target cell to which UE should handover upon receiving cell off indication is received (650),
   UE initiates handover to target cell as described in method 2 (670).
Else (i.e., if RRCReconfiguration with information about the target cell to which UE should handover upon receiving cell of indication is not received) (650),
   UE triggers RRC Re-establishment procedure as described in method 1 (660). During the RRC Re-establishment, UE select cell other than Cell X.

### Method 4

One or more UEs are in RRC_CONNECTED in a Cell (e.g., Cell X). Network (e.g., gNB or base station or DU or CU of this cell) decides to switch off cell for energy savings. Cell can be an SpCell or an SCell.

Network sends Cell Off indication to UEs. The Cell Off indication is sent over the downlink of Cell X or any other cell whose downlink is being received by the UEs in RRC_CONNECTED.
The Cell Off indication can be indicated/signaled in MAC CE or DCI or RRC message.
   In case MAC CE is used, the PDCCH scheduling the TB including the MAC CE is addressed to C-RNTI or pre-defined RNTI or common RNTI signaled by RRC (e.g., RRCReconfiguration message). PDCCH addressed to C-RNTI or pre-defined RNTI or common RNTI means the CRC of DCI transmitted on PDCCH is scrambled by the C-RNTI or pre-defined RNTI or common RNTI. Common RNTI can be signaled by network when the UE is in RRC_CONNECTED state.
   In case DCI is used, the PDCCH is addressed to C-RNTI or pre-defined RNTI or common RNTI signaled by RRC (e.g., RRCReconfiguration message).
   In case RRC message is used, the PDCCH scheduling the TB including the RRC message can be addressed to C-RNTI or pre-defined RNTI or common RNTI signaled by RRC (e.g., RRCReconfiguration message).
The Cell Off indication can also be signaled/indicated in system information (SI), e.g., MIB or SIB1 or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to P-RNTI.
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

Upon receiving Cell Off indication:
If the cell to be switched off is SCell,
   UE releases the SCell or deactivate the SCell.
If the cell to be switched off is PSCell,
   UE releases the SCG or deactivates the SCG or UE declares SCG RLF.
If the cell to be switched off is PCell,
   UE perform the operation as described in method 1 or method 2 or method 3.

### Method 5

One or more UEs are in RRC_CONNECTED in a Cell (e.g., Cell X). Network (e.g., gNB or base station or DU or CU of this cell) decides to switch off cell for energy savings. Cell can be an SpCell or an SCell.

Network sends Cell Off indication to UEs. The Cell Off indication is sent over the downlink of Cell X or any other cell whose downlink is being received by the UEs in RRC_CONNECTED.
The Cell Off indication can be indicated/signaled in MAC CE or DCI or RRC message.
   In case MAC CE is used, the PDCCH scheduling the TB including the MAC CE is addressed to C-RNTI or pre-defined RNTI or common RNTI signaled by RRC (e.g., RRCReconfiguration message). PDCCH addressed to C-RNTI or pre-defined RNTI or common RNTI means the CRC of DCI transmitted on PDCCH is scrambled by the C-RNTI or pre-defined RNTI or common RNTI. Common RNTI can be signaled by network when the UE is in RRC_CONNECTED state.
   In case DCI is used, the PDCCH is addressed to C-RNTI or pre-defined RNTI or common RNTI signaled by RRC (e.g., RRCReconfiguration message).
   In case RRC message is used, the PDCCH scheduling the TB including the RRC message can be addressed to C-RNTI or pre-defined RNTI or common RNTI signaled by RRC (e.g., RRCReconfiguration message).
The Cell Off indication can also be signaled/indicated in system information (SI), e.g., MIB or SIB1 or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to P-RNTI.
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

Upon receiving Cell Off indication:
If the cell to be switched off is SCell,
   UE releases the SCell or deactivate the SCell.
If the cell to be switched off is PSCell,
   UE releases the SCG or deactivates the SCG or UE declares SCG RLF.
If the cell to be switched off is PCell,
   UE can switch PUCCH SCell (if available) to PCell; or
   UE can switch another activated SCell (if available) to PCell; or
   If SCG is available, Switch SCG to MCG, PSCell is changed to PCell; or
   UE perform the operation as described in method 1 or method 2 or method 3,

### Method 6

One or more UEs are in RRC_IDLE/INACTIVE in a Cell (e.g., Cell X). Network (e.g., gNB or base station or DU or CU of this cell) decides to switch off cell for energy savings. Cell X can be an SpCell or an SCell.

Network sends Cell Off indication to UEs. The Cell Off indication is sent over the downlink of Cell X.
The Cell Off indication can also be signaled/indicated in system information (SI), e.g., MIB or SIB1 or any other SIB.
   Paging with SI update indication+cell off indication in SIB1 or any other SIB.
The Cell Off indication can be signaled/indicated in Short message. Short message is included in DCI of PDCCH addressed to P-RNTI transmitted in paging occasion.
The Cell Off indication can be signaled/indicated in paging message. Paging message is scheduled by PDCCH addressed to P-RNTI.
The Cell Off indication can be signaled/indicated in DCI of paging early indication (PEI), wherein PEI is the PDCCH addressed to P-RNTI transmitted before the paging occasion in PDCCH occasions of PEI.
The Cell Off indication can be signaled/indicated in DCI of PDCCH addressed to P-RNTI transmitted in paging occasion.

The Cell Off indication can be signaled/indicated using low power wakeup signal transmitted in low power wakeup signal occasion.

Upon receiving Cell Off indication in RRC_IDLE/RRC_INACTIVE:
UE initiates cell reselection.
In an embodiment, UE in RRC_INACTIVE may transition to RRC_IDLE and perform cell reselection.

### Method 7

One or more UEs are in RRC_CONNECTED in a Cell (e.g., Cell X). Cell X can be an SpCell or an SCell.

Network may send RRCReconfiguration with information about one or more target cells. RRCReconfiguration can be specific to each of the one or more UEs. In an embodiment, RRCReconfiguration with information about the target cell(s) can be commonly sent to all UEs.

Network may inform which of the target cells are NES cells (or for which NES mode is activated). This can be done by sending a separate list of NES target cells and non NES target cells or alternately there can be single list of target cells and for each target cell network indicate whether it is NES Cell (or if NES mode is activated) or not.

Network also configure condition information on radio link quality of the target cell.

### Alternate 7-1

If condition (e.g. greater than threshold or greater than equal to threshold) information on radio link quality (e.g. RSRP or RSRQ or SINR) of at least one of the target cell is met:
If condition is met for several target cells, UE selects the NES Cell if NES Cell is one of the target cell for which condition is met. If there is no NES Cell in the list of target cells for which condition is met, UE select any or target cell with best radio quality amongst these.
UE then initiate handover towards the target cell.

### Alternate 7-2

When the network decides to switch off cell, its sends Cell Off indication to UE as described in other methods.

Upon receiving Cell Off indication (or group handover indication), if condition information (e.g. greater than threshold or greater than equal to threshold) on radio link quality (e.g. RSRP or RSRQ or SINR) of at least one of the target cell is met:
If condition is met for several target cells, UE select the NES Cell if NES Cell is one of the target cell for which condition is met. If there is no NES Cell in the list of target cells for which condition is met, UE select any or target cell with best radio quality amongst these.
UE then initiate handover towards the target cell.

### Alternate 7-3

When the network decides to switch off cell, its sends Cell Off indication to UE as described in other methods (or group handover indication).
UE select the NES Cell from list of target cells, if included. Otherwise, UE select non NES Cell (or UE select non NES cell based on radio link quality (e.g. RSRP or RSRQ or SINR)).
UE then initiate handover towards the target cell.

### Method 8

In the methods described in this disclosure, Cell Off indication may include physical cell identity(s) (PCI(s)) of cell(s) to be switched off. In an embodiment, Cell Off indication may include carrier frequency (e.g. Absolute Radio Frequency Channel Number (ARFCN) or index to list of ARFCNs) to indicate switching off of all cells on the carrier frequency. In an embodiment, Cell Off Indication may include a bit map wherein each bit corresponds to a cell:
A list (List X) of cells for which cell off indication can be sent is transmitted by gNB in RRCReconfiguration message or SI.
Bits in bitmap are mapped from least significant bit (LSB) to most significant bit (MSB) or MSB to LSB to cells in the order in which they appear in the list X.

In an embodiment radio bearer for transmitting Cell Off indication common for all UEs can be one of the following:
signaling radio bearer 0 (SRB 0) is used for transmitting Cell off Indication.
(Alt) A new SRB can be defined.
   Alt 1: No protection (no encryption, no integrity protection) for the new SRB.
   Alt 2: Security key for this can be common for all UEs in cell and can be shared by gNB to all UEs in advance using dedicated signaling for the new SRB. MAC-I is generated for cell off indication using this security key and verified by UE when UE receives Cell Off indication.

In an embodiment, Cell Off Indication can be replaced by group handover command signaled to UE using MAC CE or DCI or RRC message.

FIG. 7 is a block diagram of a terminal according to an embodiment of the disclosure.

Referring to FIG. 7, a terminal includes a transceiver 710, a controller 720 and a memory 730. The controller 720 may refer to a circuitry, an application-specific integrated circuit (ASIC), or at least one processor. The transceiver 710, the controller 720 and the memory 730 are configured to perform the operations of the UE illustrated in the figures, e.g., FIGS. 1 to 6, or described above. Although the transceiver 710, the controller 720 and the memory 730 are shown as separate entities, they may be realized as a single entity like a single chip. Or, the transceiver 710, the controller 720 and the memory 730 may be electrically connected to or coupled with each other.

The transceiver 710 may transmit and receive signals to and from other network entities (e.g., a base station or another terminal).

The controller 720 may control the UE to perform functions according to one of the embodiments described above.

In an embodiment, the operations of the terminal may be implemented using the memory 730 storing corresponding program codes. Specifically, the terminal may be equipped with the memory 730 to store program codes implementing desired operations. To perform the desired operations, the controller 720 may read and execute the program codes stored in the memory 730 by using a processor or a central processing unit (CPU).

FIG. 8 is a block diagram of a base station according to an embodiment of the disclosure.

Referring to FIG. 8, a base station includes a transceiver 810, a controller 820 and a memory 830. The transceiver 810, the controller 820 and the memory 830 are configured to perform the operations of the network (e.g., gNB) illustrated in the figures, e.g., FIGS. 1 to 6, or described above. Although the transceiver 810, the controller 820 and the memory 830 are shown as separate entities, they may be realized as a single entity like a single chip. The transceiver 810, the controller 820 and the memory 830 may be electrically connected to or coupled with each other.

The transceiver 810 may transmit and receive signals to and from other network entities, e.g., a terminal. The controller 820 may control the base station to perform functions according to one of the embodiments described above. The controller 820 may refer to a circuitry, an ASIC, or at least one processor. In an embodiment, the operations of the base station may be implemented using the memory 830 storing corresponding program codes. Specifically, the base station may be equipped with the memory 830 to store program codes implementing desired operations. To perform the desired operations, the controller 820 may read and execute the program codes stored in the memory 830 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving, from a base station, information indicating a cell off of a first cell; and
performing an operation based on the information, according to whether the first cell is a secondary cell (SCell), or a primary secondary cell group cell (PSCell), or a primary cell (PCell),
in case that the first cell is the SCell, the SCell is released or deactivated,
in case that the first cell is the PSCell, a secondary cell group (SCG) including the PSCell is released or deactivated, or a radio link failure (RLF) is declared for the SCG, and
in case that the first cell is the PCell, a second cell is switched to a new PCell, a radio resource control (RRC) re-establishment is performed, or a handover from the first cell to a third cell is performed.

2. The method of claim 1, wherein the second cell includes a physical uplink control channel (PUCCH) SCell, an activated SCell, or the PSCell.

3. The method of claim 2, wherein, in case that the second cell includes the PSCell, the SCG is switched to a master cell group (MCG).

4. The method of claim 1, wherein the information is received in an RRC connected state, via a master information block (MIB), a system information block (SIB), an RRC signaling, a medium access control (MAC) control element (CE), or downlink control information (DCI).

5. A method performed by a base station in a wireless communication system, the method comprising:
transmitting, to a terminal, information indicating a cell off of a first cell; and
performing an operation based on the information, according to whether the first cell is a secondary cell (SCell), or a primary secondary cell group cell (PSCell), or a primary cell (PCell),
in case that the first cell is the SCell, the SCell is released or deactivated,
in case that the first cell is the PSCell, a secondary cell group (SCG) including the PSCell is released or deactivated, or a radio link failure (RLF) is reported for the SCG, and
in case that the first cell is the PCell, a second cell is switched to a new PCell, a radio resource control (RRC) re-establishment is performed, or a handover from the first cell to a third cell is performed.

6. The method of claim 5, wherein the second cell includes a physical uplink control channel (PUCCH) SCell, an activated SCell, or the PSCell, and
wherein, in case that the second cell includes the PSCell, the SCG is switched to a master cell group (MCG).

7. The method of claim 5, wherein the information is transmitted in an RRC connected state, via a master information block (MIB), a system information block (SIB), an RRC signaling, a medium access control (MAC) control element (CE), or downlink control information (DCI).

8. A terminal in a wireless communication system, the terminal comprising:
a transceiver; and
a controller coupled with the transceiver and configured to:
receive, from a base station, information indicating a cell off of a first cell, and
perform an operation based on the information, according to whether the first cell is a secondary cell (SCell), or a primary secondary cell group cell (PSCell), or a primary cell (PCell),
in case that the first cell is the SCell, the SCell is released or deactivated,
in case that the first cell is the PSCell, a secondary cell group (SCG) including the PSCell is released or deactivated, or a radio link failure (RLF) is declared for the SCG, and
in case that the first cell is the PCell, a second cell is switched to a new PCell, a radio resource control (RRC) re-establishment is performed, or a handover from the first cell to a third cell is performed.

9. The terminal of claim 8, wherein the second cell includes a physical uplink control channel (PUCCH) SCell, an activated SCell, or the PSCell.

10. The terminal of claim 9, wherein, in case that the second cell includes the PSCell, the SCG is switched to a master cell group (MCG).

11. The terminal of claim 8, wherein the information is received in an RRC connected state, via a master information block (MIB), a system information block (SIB), an RRC signaling, a medium access control (MAC) control element (CE), or downlink control information (DCI).

12. A base station in a wireless communication system, the base station comprising:
a transceiver; and
a controller coupled with the transceiver and configured to:
transmit, to a terminal, information indicating a cell off of a first cell, and
perform an operation based on the information, according to whether the first cell is a secondary cell (SCell), or a primary secondary cell group cell (PSCell), or a primary cell (PCell),
in case that the first cell is the SCell, the SCell is released or deactivated,
in case that the first cell is the PSCell, a secondary cell group (SCG) including the PSCell is released or deactivated, or a radio link failure (RLF) is reported for the SCG, and
in case that the first cell is the PCell, a second cell is switched to a new PCell, a radio resource control (RRC) re-establishment is performed, or a handover from the first cell to a third cell is performed.

13. The base station of claim 12, wherein the second cell includes a physical uplink control channel (PUCCH) SCell, an activated SCell, or the PSCell.

14. The base station of claim 13, wherein, in case that the second cell includes the PSCell, the SCG is switched to a master cell group (MCG).

15. The base station of claim 12, wherein the information is transmitted in an RRC connected state, via a master information block (MIB), a system information block (SIB), an RRC signaling, a medium access control (MAC) control element (CE), or downlink control information (DCI).
